(19) United States
(12) Patent Application Publication
(10) Pub. No.: US 2006/0029693 A1
(43) Pub. Date: Feb. 9, 2006

(54) TREATING CEREAL GRAINS WITH NON-PROTEIN NITROGEN TO IMPROVE GRAIN DIGESTIBILITY

(75) Inventors: Paul J. Defoor, Canyon, TX (US); Brett A. Gardner, Garden City, KS (US); Michael L. Ray, Guymon, OK (US)

Correspondence Address: MARY M LEE, P.C., 1300 E. NINTH STREET, SUITE 4, EDMOND, OK, 73034-5760, US

(73) Assignee: BEEF SOLUTIONS, L.L.C., Garden City, KS (US)

(21) Appl. No.: 10/906,002

(22) Filed: Jan. 30, 2005

Related U.S. Application Data
(60) Provisional application No. 60/599,384, filed on Aug. 6, 2004.

(51) Int. Cl. A23K 1/22

(52) U.S. Cl. 426/69

(57) ABSTRACT

Feed grains for livestock rations or ethanol production are treated with a solution containing a non-protein nitrogen compound, such as urea, to enhance digestibility. The enhanced digestibility of the treated grain improves the feed utilization efficiency of the livestock ration. The treatment solution of this invention may be used with or without accompanying mechanical processing, such as dry-rolling.

### CROSS REFERENCE TO RELATED APPLICATIONS

This application claims the benefit of the filing date of provisional application Ser. No. 60/599,384, entitled “Treating Cereal Grains with Non-Protein Nitrogen,” filed Aug. 6, 2004, the contents of which are incorporated herein by reference. This application is related to application Ser. No. ______ [attorney docket no. 3527-002] filed on even date herewith, entitled “Treating Cereal Grains with Non-Protein Nitrogen to Improve Moisture Appreciation,” the contents of which are incorporated herein by reference.

### FIELD OF THE INVENTION

The present invention relates generally to treating cereal grains and, more particularly but without limitation, to cereal grains used in livestock rations, ethanol production and other applications.

### BACKGROUND OF THE INVENTION

Cereal grains are the predominant source of energy fed to confined cattle in the United States. Cereal grains also are the predominant feedstock for ethanol production in this country. In both these applications, the digestibility of the grain is an important factor. As used herein, “digestibility” means the efficiency with which the starch in the grain can be converted to useable energy. Commonly, grain digestibility is enhanced by processing the grain to fracture the seed coat, which amplifies exposed surface area of the starch.

The major processing methods for grain to be used in livestock rations or ethanol production are steam flaking, rolling without steam (commonly referred to as dry-rolling), and cracking. All of these processes fracture or disrupt the tough outer covering of the grain kernels. Of these various methods, steam flaking produces the greatest increases in digestibility as compared to heat-free techniques. However, the high cost of energy for steam generation relative to the price of grain in some regions makes steam flaking cost prohibitive. Consequently, many cattle feeders dry-roll grain, sacrificing better digestibility in favor of lower processing costs. Energy costs in ethanol plants also create a need for improved production efficiency.

In an effort to improve the effects of heatless fracturing techniques, surfactants or other chemicals, usually in combination with water, are applied to the grains prior to processing. Treatment with these “grain conditioners” softens the outer coat and improves the effects of mechanical processing and increases the rate of moisture uptake by the grain. However, even with these chemical treatments, digestibility of dry-rolled grains is inferior to steam flaking. Thus, there is a need for a method for treating grain to improve digestibility that rivals steam flaking in effectiveness without the associated cost.

### SUMMARY OF THE INVENTION

The present invention comprises a method for treating grain for use in livestock rations. In accordance with the method, the grain is contacted with a non-protein nitrogen and a liquid carrier at ambient temperature prior to mixing the grain with non-grain ration ingredients to form the ration. In another aspect, the present invention comprises a method for treating grain to improve digestibility. The grain is contacted with an effective amount of a non-protein nitrogen and a liquid carrier for a time sufficient to improve significantly the grain digestibility. In a further aspect, the present invention comprises a composition consisting essentially of a non heat-treated grain, a non-protein nitrogen, and a liquid carrier, and a livestock ration comprising such a composition.

### DETAILED DESCRIPTION OF THE PREFERRED EMBODIMENT

In accordance with the present invention, there is provided a heat-free chemical process for treating cereal grain for use in livestock rations, ethanol production and in other applications where improved digestibility is desired. As used herein “livestock” means cattle, sheep, goats, pigs and other animals that are bred for supplying meat or dairy products. The livestock ration of the present invention is intended primarily for ruminant animals, but these methods and compositions may have other applications.

“Ration” refers to a composite comprising cereal grain as the carbohydrate energy source and other ration ingredients to form a livestock diet. As used herein, “non-grain ration ingredients” means any non-grain ingredient typically included in a livestock ration, including roughage, supplements, and liquid. Roughage usually is alfalfa or hay or an ensiled plant (silage). The liquid may be a combination of fat and molasses. The supplements typically include protein additives, vitamins, minerals and sometimes drugs. Roughage usually is alfalfa or hay or an ensiled plant (silage). The liquid may be a combination of fat and molasses. The supplements typically include protein additives, vitamins, minerals and sometimes drugs. Urea or other non-protein nitrogen compounds (“NPN”) commonly are used as crude protein supplements (nitrogen source) in livestock rations.

Cereal grains are the most common source of carbohydrates in rations for livestock and are used as the carbohydrate source in the formation processes used in ethanol production. As used herein, “grain” means the unhusked or threshed seed of one of the cereal plants, including but not limited to barley, milo (sorghum), rye, oats, wheat, rice, millet, maize (corn), and mixtures thereof. The present invention is directed to improving the digestibility of the grains used in these applications, which in turn increases the feed utilization efficiency (“FUE”), while minimizing the processing costs by avoiding the use of heat.

In the methods and compositions of this invention, NPN does double duty. In the pretreatment phase, the NPN serves as a grain conditioner to increase digestibility. The NPN used to condition the grain then contributes to the total NPN assigned to the ration as a protein supplement. Thus, the need for non-nutritive grain conditioners is eliminated and the treated grain achieves a level of digestibility comparable to that provided by heat-assisted techniques. When the treated grain is used in ethanol production, the NPN begins the process of breaking down amylose and amylopectin and also contributes a needed nitrogen source for yeast to convert carbohydrates to ethanol.

In accordance with the method of the present invention, grain is contacted with an NPN compound. As used herein, “non-protein nitrogen” includes but is not limited to urea, uric acid, biuret, ethylene urea, ammonia, anhydrous ammonia, aqueous ammonia, urea-ammonia nitrate, ammonium salts, propionamide, butyramide, formamide, acetamide, dicyanodiamide, isobutane diurea, creatinine, creatine, lactosyl urea, urea phosphate, fermented ammoniated condensed whey, and mixtures thereof. NPN's come in liquid or solid forms.

While not wishing to be bound by theory, it is believed that the NPN, or urea, accelerates the breakdown of the starch-protein bonds on the grain kernels. Perhaps, the urea denatures the starch-protein matrix.

The contact between the grain and the NPN should be carried out under conditions which facilitate the distribution of the NPN to substantially all the grain kernels and to ensure that good coverage of the seed coat is achieved. To this end, usually the NPN will be contacted with the grain in the presence of a liquid carrier. Preferably, the liquid carrier is water, but other liquids, such as alcohol, condensed distillers solubles, fruit juices, organic or inorganic salt solutions, could be substituted. More preferably, the NPN is premixed in water to form a treatment solution.

The amount of NPN may vary depending on the particular compound selected. The amount of NPN should be an effective amount of NPN, that is, an amount sufficient to produce a significant improvement in the grain digestibility, given the other variables, such as the form of the NPN (liquid or dry), the type of grain being treated, the period of time during which the grain is contacted with the NPN, the mixing procedure employed, the ambient temperature, the concentration of nitrogen, and the nature and amount of liquid carrier used in conjunction with the NPN.

An improvement in grain digestibility may be measured by any scientifically sound procedure. For example, in vitro dry matter digestibility may be measured by the procedure described by P. J. Defoor, M. L. Galyean, N. A. Cole, and O. R. Jones, in Effects of planting density and processing method on laboratory characteristics of grain sorghum for ruminant, J. Anim. Sci., Vol. 78 (2000), pp. 2032-2038. This article is incorporated herein by reference.

Preferably, the amount of NPN is selected to provide between about 0.01 and about 3.5 grams nitrogen per pound of grain. More preferably, the amount of NPN is selected to provide between about 0.25 and about 2 grams nitrogen per pound of grain. Most preferably, the amount of NPN is selected to provide about 0.5 gram nitrogen per pound of grain. An ideal amount of urea in the treatment solution is about 1 gram per pound of grain. In the preferred practice of this invention, where the NPN is urea, the urea content in the treatment solution is present in amount equal to at least about 1.0 weight percent, more preferably from about 2.0 to about 25 weight percent, and most preferably from about 3.0 to about 12 weight percent.

When used as a conventional protein supplement in livestock rations, NPN usually is added at the rate of about about 0.33-0.56 weight percent (0.7-1.2% urea) of the ration. Thus, in the preferred practice of this invention, the amount of NPN used to pre-treat the grain ultimately will account for approximately 5 to 25% of the NPN normally used as a dietary supplement. When used as a nitrogen source in ethanol production, NPN is added at the rate of about 0.02-0.06 weight percent (0.04-0.13% urea) to total grain mixture and will provide the majority of the NPN needed as a nitrogen source for yeast to convert starch to alcohol.

The grain treatment solution may contain other additives. For example, often it is desirable to add surfactant to the treatment solution in an amount sufficient to improve the ability of the treatment solution to coat the grain. Preferably, the treatment solution comprises from about 0.1 to about 1.0 weight percent surfactant, more preferably from about 0.5 to about 0.75 weight percent surfactant, even more preferably from about 0.6 to about 0.7 percent surfactant. A surfactant content of about 0.64 weight percent is ideal for most applications.

The amount of liquid carrier is selected based on the ability of the particular liquid to dissolve or suspend and distribute the NPN in the grain to achieve even coverage of the NPN on the seed coat of the grain. Preferably, the amount of water is between about 1 and about 100 grams per pound of grain. More preferably, the amount of water is between about 20 and about 60 grams per pound of grain. Most preferably, the amount of water is about 32 grams per pound of grain.

Where the NPN and the liquid carrier are premixed in a treatment solution, contact with the grain can be carried out efficiently by spraying the solution over the grain while the grain is being stirred, as in a mixing auger. However, various other methods for dispersing the treatment solution among the grain kernels will be apparent and these are within the scope of the present invention.

The reaction time, or the time during which the contact between the NPN, liquid carrier and the grain is sustained before the treated grain is mixed into the ration and/or consumed by the animal, may vary depending on the other variables. Preferably, the reaction time is sufficient to improve grain digestibility significantly. As regards this invention, an improvement in digestibility equal to or exceeding about one percent (1%) by weight is considered significant.

Where the NPN is urea and the liquid carrier is water, and these are premixed in a treatment solution as described previously, and the goal is mainly improved grain digestibility, a preferred minimum reaction time is at least 1 hour. More preferably, the reaction time is at least 2 hours, and most preferably, the reaction time in this embodiment is at least 4 hours.

As described above, one of the advantages of the present invention is the attainment of improved digestibility without the cost of steam flaking or other heat treatments. Thus, the contact between the grain and the NPN and the liquid carrier preferably is carried out at ambient temperature and pressure.

Although not essential, it may be beneficial to use dry-rolled grain or grain that is otherwise fractured in the inventive compositions. Alternately, the grain can be fractured as part of the inventive method, either before, during or after the grain is contacted with the NPN and the liquid carrier. In the most preferred practice of the method, the grain is fractured prior to the application of the NPN.

“Fractured” or “fracturing” is used herein to denote any and all methods, chemical, thermal and mechanical, that break, crush, grind, crimp, flake, pop, crack, shred or in any way disrupt the outer seed coating of the grain to expose the starch contained within. Perhaps the most commonly used technique for fracturing grain is dry-rolling. However, the present invention is not so limited.

Having treated grain as heretofore described, there results a composition comprising a non-heat treated grain, a non-protein nitrogen, and a liquid carrier. In one preferred embodiment, the composition consists essentially of these three ingredients. This grain composition then can be added to or mixed with other non-grain ration ingredients to form a livestock ration, or it can be utilized in ethanol production in an otherwise conventional manner.

Hydrolytic enzymes may be added to the treatment solution, or otherwise contacted with the grain, to further enhance the “pre-digesting” effect of NPN. For example, amylase may be added in an amount sufficient to cleave about 80 grams of starch per pound of grain. “Hydrolytic enzymes” refers to enzymes that accelerate the hydrolysis of starch and glycogen or their intermediate hydrolysis products. These include enzymes such as amylases (alpha-amylase and beta-amylase), xylanase, and amyloglucosidase. While not wishing to be bound by theory, it is believed that the amylase cleaves glucose units liberated after the urea has denatured the protein matrix protecting the starch, making the starch polymers more accessible to the enzyme.

Other chemicals may have a positive interactive effect on the NPN. For example, a base such as sodium hydroxide (NaOH) may provide excellent results.

The following examples illustrate the methods and compositions of the present invention.

### EXAMPLE 1

A trial was conducted to compare the effects of treating dry-rolled corn with water as opposed to an aqueous solution of urea to determine the relative effects on in vitro dry matter digestibility, or “IVDMD.” Ten (10) one-pound samples of dry-rolled corn from a single (first) source were spread out in separate beds. Five of the beds (Group 1) were treated with water at the rate of 32 grams of water per pound of grain (7% weight percent of mixture). Another five (Group 2) were treated with an aqueous solution of urea comprising 32 grams water per pound of grain, and 1 gram urea per pound of grain (˜0.2% of diet).

The treatment was carried out by spraying the beds with the treatment solution and then mixing the treated grain manually to ensure even coating of the grain kernels. Each treated sample then was allowed to sit at room temperature overnight, or approximately 18 hours, prior to in vitro fermentation for 4 hours.

Resulting IVDMD data are shown below in Table 1.

TABLE 1

| | Water Only | | |
|---|---|---|---|
| | (Control) | Water + Urea | |
| | Group 1 | Group 2 | |
| | (Samples 1-5) | (Samples 6-10) | % improvement |
| | 23.8% | 33.8% | |
| | 25.2% | 27.6% | |
| | 24.1% | 26.2% | |
| | 20.1% | 28.9% | |
| | 22.2% | 29.2% | |
| Mean | 23.1% | 29.1% | +26.3% |

These data show a 26.3% increase in IVDMD as compared to the control samples. Based on these data, it was concluded that treatment with the urea solution improved grain digestibility.

### EXAMPLE 2

Another trial was conducted to evaluate the effect of compounds that may disrupt the starch protein matrix to expose the starch. Sodium hydroxide was selected for this trial because it is known to have protein denaturing properties but not to affect adversely the microbial populations in the rumen. Twenty one-pound samples of dry-rolled corn from a single (second) source were prepared as in Example 1 and divided into four groups of five. Group 1 samples were treated with water as a control (32 grams of water per pound of grain); Group 2 samples were treated with an aqueous solution of urea (32 grams of water per pound of grain, and 1 gram urea per pound of grain); Group 3 samples were treated with a solution of sodium hydroxide and water (32 grams of water per pound of grain, and 4% by weight sodium hydroxide); and Group 4 samples were treated with a solution of sodium hydroxide, urea and water (32 grams of water per pound of grain, 4% sodium hydroxide, and 1 gram urea per pound of grain). All the samples were then allowed to sit at room temperature overnight for approximately 12 hours prior to in vitro fermentation for 8 hours.

The resulting data are shown in Table 2 below

TABLE 2

| | Water Only | | | |
|---|---|---|---|---|
| | (Control) | Water + Urea | Water + NaOH | Water + Urea + |
| | Group 1 | Group 2 | Group 3 | NaOH Group 4 |
| | (Samples | (Samples | (Samples | (Samples |
| | 1-5) | 6-10) | 11-15) | 16-20) |
| | 43.9% | 44.8% | 37.8% | 47.9% |
| | 41.4% | 43.3% | 38.7% | 49.6% |
| | 44.3% | 45.4% | 40.0% | 50.3% |
| | 41.1% | 42.4% | 40.9% | 42.4% |
| | 43.0% | 43.6% | 38.1% | 47.2% |
| Mean | 42.7% | 43.9% | 39.1% | 47.5% |

These data show that the urea solution (Group 2) provided a 2.8% improvement in IVDMD compared to water (Group 1), that the sodium hydroxide solution (Group 3) resulted in an 8.4% decrease in IVDMD as compared to the control, and that the combination of urea and sodium hydroxide (Group 4) provided an 11.2% increase in IVDMD as compared to the control solution.

The data from this trial were consistent with the data from trial 1 in showing that treatment with urea improves grain digestibility. The lower IVDMD response observed in Trial 2 compared to Trial 1 (2.81% vs. 26.25%) indicates that most of the benefit of urea occurs in the first 4 hours of digestion. Because IVDMD analysis occurs in a closed system, longer periods of digestibility allow control treatments to “catch up” to treatments that enhance rate of digestibility. It would be reasonable to suspect that the rate of digestibility for the second 4 hours of the fermentation process could be much slower if chemical treatment only permeated the outer layers of the grain particles.

In the live animal, enhancements in rate of digestibility translate into enhancements in extent of digestibility because grains are constantly passing out of the animal's fermentation compartment, the rumen. Thus, because rate of digestion and rate of passage are competing processes, increasing rate of digestion is a major factor for improving extent of digestibility in the animal. Furthermore, variation in observed responses in IVDMD data from trial-to-trial is not uncommon and might be attributed to differences in rumen fluid microbe composition, biological variation, or differences in starch type among genetic varieties of corn samples, or a combination of any of these factors.

Nevertheless, the results of Trial 2 indicate a positive benefit to using urea as a cost effective means to improve grain digestibility. Trial 2 also indicated that additional improvement in grain digestibility might be achieved by combining urea with other products that could work synergistically with urea to make starch more available to rumen microorganisms for their use in converting starch to usable energy for the animal.

From these data we concluded that treatment of the grain with urea, or with urea and sodium hydroxide, improved IVDMD. These data suggest a positive interaction between sodium hydroxide and the urea, though the precise mechanism of this interaction is unknown.

### EXAMPLE 3

To investigate the effect of other compounds, namely, hydrolytic enzymes, a third trial was conducted. This third trial was designed to determine the effect of hydrolytic enzymes on grain digestibility. This specific trial tested amylase, an enzyme known to break down amylose and amylopectin into shorter polymers of glucose molecules. The trial compared the effect of treating grain with a solution of urea, amylase, and water versus the control treatment of water only on IVDMD. Ten one-pound samples of dry-rolled corn from a single (third) source were prepared as described above and allowed to sit overnight, or about 12 hours, prior to in vitro fermentation for 8 hours.

Group 1 samples were treated with water as a control (32 grams of water per pound of grain). Group 2 samples were treated with a solution of urea, amylase enzyme and water (32 grams of water per pound of grain, amylase enzyme sufficient to cleave 80 grams of starch per pound of grain, and urea in an amount equal to about 1 gram per pound of grain).

Resulting in vitro dry matter disappearance data are shown below.

TABLE 3

| | Water Only | | |
|---|---|---|---|
| | (Control) | Water + Urea + | |
| | Group 1 | Amylase Group 2 | |
| | (Samples 1-5) | (Samples 6-10) | % improvement |
| | 51.4% | 61.9% | |
| | 51.2% | 58.9% | |
| | 52.8% | 62.0% | |
| | 51.6% | 60.6% | |
| Mean | 51.7% | 60.8% | +17.6% |

The results showed that the test solution improved IVDMD of the corn 17.6% over that achieved with water only. From these data, it was concluded that urea combined with a hydrolytic enzyme provided significant improvement in IVDMD.

### EXAMPLE 4

Trial 4 was similar to Trial 3, except that the samples were tested by an independent commercial laboratory. Two groups of three one-pound samples each of dry-rolled corn from a single (fourth) source were prepared as in trial 3. Group 1 was treated with water (control), and group 2 was treated with the same urea, amylase and water solution and allowed to sit for 24 hours prior to in vitro fermentation for 8 hrs. The test solutions were the same as those used in Example 3.

Overall means for each sample is shown in Table 4 below.

TABLE 4

| | Water Only | | |
|---|---|---|---|
| | (Control) | Water + Urea + | |
| | Group 1 | Amylase Group 2 | |
| | (Samples 1-3) | (Samples 4-6) | % improvement |
| | 64.4% | 67.0% | |
| | NA | 69.1% | |
| | NA | 67.8% | |
| Mean | 64.4% | 68.0% | +5.6% |

The data showed a 5.6% improvement in the IVDMD in the samples treated with the amylase and urea solution compared to the control group. This was believed to confirm the results of trial 3 that the urea+amylase treatment significantly improves the digestibility of dry-rolled corn.

As stated previously, substantial trial-to-trial differences can exist due to biological variation the rumen microbe population of the animals from which the rumen fluid used in the analysis is collected, genetic variety of starch in the grain, and other factors. One or more of these variables likely explains the difference in magnitude between the treatments and controls across Trials 3 and 4.

### EXAMPLE 5

Trial 5 was conducted to compare the effects of the treatment solutions used in trials 1-4 above with steam flaking. Sixteen samples of dry-rolled corn, all from a single (fifth) source were treated as described above and allowed to sit for 24 hours prior to in vitro fermentation for 8 hrs.

Group 2

Group 1 samples were treated with water only as a control (32 grams of water per pound of grain). Group 2 samples were treated with a solution of sodium hydroxide (4% sodium hydroxide), amylase enzyme (sufficient to cleave 80 grams of starch per pound of grain), and water (32 grams of water per pound of grain). Group 3 samples were treated with a solution of water (32 grams of water per pound of grain), sodium hydroxide (4% sodium hydroxide), and urea (1 gram urea per pound of grain). Group 4 samples were treated with a solution of urea (about 1 gram per pound of grain), amylase enzyme (sufficient to cleave 80 grams of starch per pound of grain), and water (32 grams of water per pound of grain). Group 5 samples (dry-rolled corn from the same source) were steam flaked according to standard procedures to an approximate starch availability (gelatinization) of 55% (weight=30 lb/bu).

In vitro dry matter digestibility data for the five sets of samples are shown below.

TABLE 5

| | Water Only | | Water + NaOH | Water + Urea + | |
|---|---|---|---|---|---|
| | (control) | Water + NaOH + | + Urea | Amylase | Steam Flaking |
| | Group 1 | Amylase Group 2 | Group 3 | Group 4 | Group 5 |
| | (Samples 1-4) | (Samples 5-9) | (Samples 10-13) | (Samples 14-17) | (Samples 18-21) |
| | 51.38% | 51.20% | 50.80% | 58.80% | 57.41% |
| | 51.20% | 51.93% | 51.82% | 59.28% | 53.06% |
| | 52.77% | 51.75% | 52.91% | 59.66% | 57.27% |
| | 51.56% | 53.20% | 55.16% | 57.91% | 56.49% |
| Mean | 51.73% | 52.02% | 52.67% | 58.91% | 56.06% |

These data showed a 0.45% improvement in IVDMD after treatment with the combination of sodium hydroxide (NaOH) and amylase. The solution containing NaOH and urea showed a 1.82% improvement in IVDMD. Urea combined with amylase resulted in a 13.88% improvement in IVDMD, whereas steam flaking improved IVDMD 8.37% compared to the control.

From these data it was concluded that the non-urea containing treatment solution (amylase and sodium hydroxide) provided a minimal increase in grain digestibility. All the urea-containing treatment solutions provided a significant improvement. The solutions combining urea with an enzyme provided the greatest improvement, even greater than that achieved with steam flaking.

Based on the above trials, it was concluded that treatment of dry-rolled grain with urea solution would significantly improve grain digestibility and, therefore, the feed utilization efficiency of a diet containing treated grain. It was further concluded that most of the benefit of the treatment occurred during the first four hours of fermentation. Still further, it was concluded that combining a hydrolytic enzyme, such as amylase, will enhance the effect of urea.

Now it will be appreciated that the present invention provides a method for treating grain for improved digestibility and water uptake comparable to steam flaking but without the cost. The methods and compositions of this invention rely on an ingredient presently used by most cattle feeders as a protein supplement, so no additional chemicals or additives are necessary.

Changes can be made in the combination and arrangement of the various parts and steps described herein without departing from the spirit and scope of the invention as defined by the following claims.

What is claimed is:

1. A method for treating grain for use in livestock rations, the method comprising:
prior to mixing the grain with non-grain ration ingredients, contacting the grain with non-protein nitrogen and a liquid carrier at ambient temperature.

2. The method of claim 1 wherein the non-protein nitrogen is urea.

3. The method of claim 2 wherein the liquid carrier is water.

4. The method of claim 3 further comprising contacting the grain with a hydrolytic enzyme prior to mixing the ration and the grain.

5. The method of claim 4 wherein the amount of urea is about 1 gram per pound of grain.

6. The method of claim 5 wherein the grain is fractured prior to the contacting step.

7. The method of claim 6 wherein the contacting step is sustained for at least about 1 hour prior to mixing the grain with the ration.

8. The method of claim 7 wherein the step is sustained for at least about 2 hours prior to mixing the grain with the ration.

9. The method of claim 8 wherein the step is sustained for at least about 4 hours prior to mixing the grain with the ration.

10. The method of claim 4 wherein the grain is fractured prior to the contacting step.

11. The method of claim 1 wherein the liquid carrier is water.

12. The method of claim 11 wherein the amount of water is about 32 grams per pound of grain.

13. The method of claim 1 wherein the liquid carrier and the non-protein nitrogen are premixed to form a treatment solution and wherein the contacting step is carried out by spraying the treatment solution onto the grain.

14. The method of claim 13 wherein the contacting step further comprises stirring the grain.

15. The method of claim 1 wherein the contacting step is sustained for at least about 1 hour prior to mixing the grain with the ration.

16. The method of claim 15 wherein the contacting step is sustained for at least about 2 hours prior to mixing the grain with the ration.

17. The method of claim 16 wherein the contacting step is sustained for at least about 4 hours prior to mixing the grain with the ration.

18. The method of claim 1 wherein the amount of non-protein nitrogen is between about 0.01 and about 3.5 grams per pound of grain.

19. The method of claim 18 wherein the amount of non-protein nitrogen is between about 0.25 and about 2.0 grams per pound of grain.

20. The method of claim 19 wherein the amount of non-protein nitrogen is about 0.5 gram per pound of grain.

21. The method of claim 1 wherein the contacting step is carried out at atmospheric pressure.

22. The method of claim 1 further comprising contacting the grain with a hydrolytic enzyme prior to mixing the ration and the grain.

23. The method of claim 22 wherein the hydrolytic enzyme is amylase.

24. The method of claim 23 wherein the amount of amylase is about enough to cleave about 80 grams of starch per pound of grain.

25. The method of claim 1 wherein the grain is fractured.

26. The method of claim 25 wherein the grain is dry-rolled.

27. The method of claim 1 further comprising fracturing the grain.

28. The method of claim 27 wherein the fracturing step is carried out prior to the contacting step.

29. The method of claim 28 wherein the fracturing step comprises dry-rolling the grain.

30. The method of claim 1 wherein the grain comprises barley, milo (sorghum), rye, oats, wheat, rice, millet, maize (corn), or a mixture thereof.

31. The method of claim 1 wherein the non-protein nitrogen is urea, wherein the liquid carrier is water, wherein the urea and water are premixed to form a treatment solution, wherein the grain is fractured, and wherein the contacting step is sustained for at least about 4 hours.

32. A method for treating grain to improve grain digestibility, the method comprising:
contacting the grain with an effective amount of non-protein nitrogen compound and a liquid carrier for a time sufficient to improve significantly the grain digestibility.

33. The method of claim 32 wherein the non-protein nitrogen is urea.

34. The method of claim 33 wherein the liquid carrier is water.

35. The method of claim 34 further comprising contacting the grain with a hydrolytic enzyme prior to mixing the ration and the grain.

36. The method of claim 35 wherein the amount of urea is about 1 gram per pound of grain.

37. The method of claim 36 wherein the grain is fractured prior to the contacting step.

38. The method of claim 37 wherein the contacting step is sustained for at least about 1 hour.

39. The method of claim 38 wherein the contacting step is sustained for at least about 2 hours.

40. The method of claim 39 wherein the contacting step is sustained for at least about 4 hours.

41. The method of claim 40 wherein the contacting step is carried out at the ambient temperature.

42. The method of claim 41 wherein the contacting step is carried out at the atmospheric pressure.

43. The method of claim 35 wherein the grain is fractured prior to the contacting step.

44. The method of claim 32 wherein the liquid carrier is water.

45. The method of claim 44 wherein the amount of water is about 32 grams per pound of grain.

46. The method of claim 32 wherein the liquid carrier and the non-protein nitrogen are premixed to form a treatment solution and wherein the contacting step is carried out by spraying the treatment solution onto the grain.

47. The method of claim 46 wherein the contacting step further comprises stirring the grain.

48. The method of claim 32 wherein the contacting step is sustained for at least about 1 hour.

49. The method of claim 48 wherein the contacting step is sustained for at least about 2 hours.

50. The method of claim 49 wherein the contacting step is sustained for at least about 4 hours.

51. The method of claim 32 wherein the amount of non-protein nitrogen is between about 0.01 and about 3.5 grams per pound of grain.

52. The method of claim 51 wherein the amount of non-protein nitrogen is between about 0.25 and about 2.0 grams per pound of grain.

53. The method of claim 52 wherein the amount of non-protein nitrogen is about 0.5 gram per pound of grain.

54. The method of claim 32 wherein the contacting step is carried out at ambient temperature.

55. The method of claim 54 wherein the contacting step is carried out at atmospheric pressure.

56. The method of claim 32 wherein the contacting step is carried out at atmospheric pressure.

57. The method of claim 32 further comprising contacting the grain with a hydrolytic enzyme.

58. The method of claim 57 wherein the hydrolytic enzyme is amylase.

59. The method of claim 58 wherein the amount of amylase is about enough to cleave about 80 grams of starch per pound of grain.

60. The method of claim 32 wherein the grain is fractured.

61. The method of claim 60 wherein the grain is dry-rolled.

62. The method of claim 32 further comprising fracturing the grain.

63. The method of claim 62 wherein the fracturing step is carried out prior to the contacting step.

64. The method of claim 63 wherein the fracturing step comprises dry-rolling the grain.

65. The method of claim 32 wherein the grain comprises barley, milo (sorghum), rye, oats, wheat, rice, millet, maize (corn), or a mixture thereof.

66. The method of claim 32 wherein the non-protein nitrogen is urea, wherein the liquid carrier is water, wherein the urea and water are premixed to form a treatment solution, wherein the grain is fractured, and wherein the contacting step is sustained for at least about 4 hours.

67. A composition consisting essentially of:
a non-heat treated cereal grain;
a non-protein nitrogen; and a liquid carrier.

68. The composition of claim 67 wherein the non-protein nitrogen is urea.

69. The composition of claim 68 wherein the liquid carrier is water.

70. The composition of claim 69 further consisting essentially of a hydrolytic enzyme.

71. The composition of claim 70 wherein the amount of urea is about 1 gram per pound of grain.

72. The composition of claim 71 wherein the grain is fractured.

73. The composition of claim 67 wherein the liquid carrier is water.

74. The composition of claim 73 wherein the amount of water is about 32 grams per pound of grain.

75. The composition of claim 67 wherein the amount of non-protein nitrogen is between about 0.01 and about 3.5 grams per pound of grain.

76. The composition of claim 75 wherein the amount of non-protein nitrogen is between about 0.25 and about 2.0 grams per pound of grain.

77. The composition of claim 76 wherein the amount of non-protein nitrogen is about 0.50 gram per pound of grain.

78. The composition of claim 67 further consisting essentially of a hydrolytic enzyme.

79. The composition of claim 78 wherein the hydrolytic enzyme is amylase.

80. The composition of claim 79 wherein the amount of amylase is about enough to cleave about 80 grams of starch per pound of grain.

81. The composition of claim 67 wherein the grain is fractured.

82. The composition of claim 81 wherein the grain is dry-rolled.

83. The composition of claim 67 wherein the grain comprises barley, milo (sorghum), rye, oats, wheat, rice, millet, maize (corn), or a mixture thereof.

84. The composition of claim 67 wherein the non-protein nitrogen is urea, wherein the liquid carrier is water, and wherein the grain is fractured.

85. A livestock ration comprising the composition of claim 67.
